(19) United States
(12) Patent Application Publication
(10) Pub. No.: US 2007/0048718 A1
(43) Pub. Date: Mar. 1, 2007

(54) System and Method for Test Creation, Verification, and Evaluation

(75) Inventor: Eric Gruenstein, Cincinnati, OH (US)

Correspondence Address: LAFKAS PATENT LLC, 7811 LAUREL AVENUE, CINCINNATI, OH, 45243, US

(73) Assignee: EXAM GRADER, LLC, Cincinnati, OH (US)

(21) Appl. No.: 11/462,859

(22) Filed: Aug. 7, 2006

Related U.S. Application Data
(60) Provisional application No. 60/595,826, filed on Aug. 9, 2005.

(51) Int. Cl. G09B 3/00

(52) U.S. Cl. 434/322

(57) ABSTRACT

The present invention is a system and method for creating and grading handwritten tests. The tests are input into a computer wherein the answers are recognized with an intelligent character recognition program and then compared to a list of possible answers. The system then automatically provides a grade for each answer and to each test.

### CROSS-REFERENCE TO RELATED APPLICATION

This application for a patent claims priority to U.S. Provisional Patent Application No. 60/595,826 as filed Aug. 9, 2005.

### BACKGROUND

The various exemplary embodiments of the present invention relate to a system and method for creating, verifying, and evaluating tests given to students or other individuals. More particularly, the various exemplary embodiments relate to a system and method for creating, verifying, and evaluating tests given to individuals in which the individuals provide answers in handwritten form, which is subsequently recognized by a computer and compared to one or more predetermined acceptable answers.

Various devices and methods have been used to create and/or grade tests given to students in order to determine the students' abilities and knowledge related to varying subjects.

The most common grading system and method is a handwritten or typed set of questions in which students provide answers in a given space. The students' answers are typically in a handwritten or typed form, and often require a great deal of time on the part of the test giver to personally and manually review and grade each individual test given.

In order to increase the efficiency on the part of a test giver in grading tests, bubble-type computer graded multiple choice tests were developed. In such tests, test questions are given on a first set of papers and test takers provide answers on a separate answer sheet. The test takers' answers typically comprise filling in boxes, bubbles, or the like corresponding to one or more possible multiple choice answers provided to answer the corresponding test question.

The bubble-type computer graded tests have drawbacks, however. Primarily, the types of questions that a test giver can create are limited. That is, the questions are typically of a format in which the student chooses from a set of answers provided. That is, the student chooses an answer from a given set of answers, chooses “true” or “false,” or the like. In such tests, though, the test taker is tested on his/her ability to recognize the correct answer, or ability to recognize and dismiss known incorrect answers in order to narrow down choices.

Questions testing an individual's ability to recognize an answer are pedagogically different from questions that test an individual's ability to recall an answer from memory without prompting of possible answers. Testing an individual's ability to recall suggests a greater ability in memory and application of knowledge. However, grading tests in which an ability to recall is tested is more time consuming to review and grade.

What is desired, then, is a means of creating, verifying, and evaluating handwritten test responses to better test an individual's ability to recall, while also being able to efficiently be evaluated and graded by the test giver.

### SUMMARY

The various exemplary embodiments include a method and a system for efficiently and effectively creating, assessing, reviewing, and grading short answer type tests. The method includes creating a test, wherein a test giver compiles one or more test questions and identifies one or more response regions in which one or more responses to the one or more test questions may be input by one or more test takers. One or more acceptable answers are designated as correct responses to each of the one or more test questions. The one or more acceptable answers are input into a computing system. The test is distributed to the one or more test takers, wherein the one or more test takers input one or more responses to the one or more test questions in the one or more response regions such that the one or more responses may be input by manual handwriting on paper. The tests are collected and scanned into the computer and then the one or more responses input into the one or more response regions by the one or more test takers are converted into an electronic format. The one or more responses to the one or more test questions are analyzed by intelligent character recognition and reviewed, wherein the one or more responses are compared to the one or more acceptable answers. The tests are graded based on a number of responses deemed to substantially compare the one or more acceptable answers to a respective question. Credit is assigned to each of the one or more test takers.

The method also may comprise manual review and evaluation of the actual handwritten responses provided by the test takers, such that the test grader may allow for full or partial credit. Such manual review and evaluation may be performed via a graphical display, e.g., computer monitor, of the one or more test takers' handwritten responses.

### DETAILED DESCRIPTION

The various exemplary embodiments of the present invention comprise a system and method for creating, verifying, and evaluating tests. Most often, such tests are for a classroom setting to test the knowledge and the recall ability of test takers, for example, students.

The first step comprises creating a test. Creating a test may be performed by the actual test giver, or any other entity, such as, for example, schools, boards of education, governmental entities of any level, private business, and the like.

The test may be created on substantially blank paper or paper comprising prewritten marks using any writing instrument such as, for example, a pen, a pencil, a marker, or a combination thereof. The test may also be created on a computer using an input device, such as, for example, a keyboard, mouse, a stylus, or a combination thereof. In an exemplary embodiment, if the test is created on paper, the test is electronically scanned to be input into a computer.

In creating the test, questions are input and one or more response regions may be left between or within questions. Such one or more response regions may be used by the test taker to supply one or more responses or answers to the corresponding question posed. In a preferred embodiment, a visible border is arranged around the response region to identify to test takers the proper place for inserting one or more answers.

Once questions are input into a computer, either directly or via a scanning means, an individual designates one or more acceptable answers to each of the questions. In addition, one indicates the one or more response regions as the areas in which answers by test takers should eventually be examined.

In another exemplary embodiment, the one or more response regions may be provided on one or more pages, separate from the associated questions. In such embodiment, an overall number of pages having response regions potentially decreases, thereby requiring a decreased overall number of pages to be scanned and evaluated by the system.

The response regions for a particular test may be located on one or more pages. Thus, test takers are not limited to a single page upon which to provide handwritten answers.

It is preferred that where there are two or more pages for responses by test takers, each page of response regions also includes at least one page number identifier by which the system recognizes the particular page of the test. By recognizing a particular page, the system may also recognize the regions in which particular response regions are located, and thereby should be evaluated. Further, including a page number identifier substantially decreases the need to scan pages sequentially, i.e., all page 1 responses by a class for a particular test, followed by scanning page 2 for an entire class, etc. In various exemplary embodiments, the page number identifier comprises a number placed in at least two predetermined locations on the response sheet. More preferably, the page number is placed in at least three predetermined locations on the response sheet.

In an exemplary embodiment, a test is created with a test template in which regions for questions and response regions are predefined. Such templates may be predefined on paper, or on a computer.

In various exemplary embodiments, the template may comprise a grid for positioning and sizing of response regions more easily and aesthetically pleasing.

In another exemplary embodiment, the template allows for correlating one or more questions with a predetermined response region size and shape. For example, in creating a test, the test giver may predetermine that question numbers 1-5 need only a response region large enough for ten letters or less. Thus, the test giver may use the template to define the response regions for question numbers 1-5 to be of a predetermined size allowing about ten letters or less by a test taker.

Whether or not the template is used by a test giver in creating the test, the size, shape, and position of one or more response regions may be manually modified by the test giver, if desired.

In designating one or more correct answers, an individual may allow for variations on a possible answer. For example, if a question asks “Who was the president of the United States in 1990?” acceptable answers may include, for example, George Bush, George H. W. Bush, George Herbert Walker Bush, President Bush, etc. Each of these is a correct and acceptable answer by a test taker. Thus, the individual creating the test inputs each as an acceptable answer or variable answer to the question.

In designating the one or more correct answers; each individual question is given a point value. In a preferred embodiment, the number of incorrect letters permitted in a response and still resulting in positive credit for a question may also be designated.

The tests created are then supplied to test takers. The test may be supplied on printed paper. The test takers input their respective answers in one or more response regions associated with each question. Upon completion of the test, the tests are collected.

After completion and collection of the tests, the test takers may be provided with an answer sheet comprising the one or more acceptable answers. This would inform the test takers of the correct answers, as predetermined by the test giver.

In a preferred embodiment, the created test comprises information such as, for example, the class subject, the teacher of the material, the test name, the date, space for a test taker's name, geographical location, school district, school name, class section, or a combination thereof.

If the tests are completed by hand on paper, it is preferred that the printed test further comprise a set of one or more registration marks for substantially aligning the digitalized version of the test page after it has been scanned into a computer for evaluation and grading. If the tests are completed on a computer that recognizes handwriting, the one or more registration marks need not be present as the test would not need to be scanned into a scanner prior to evaluation by the computer system.

In an exemplary embodiment, the computer also recognizes the handwritten or typed name of the test taker and matches the test taker's name to a predetermined list of all test takers, that is, for example, a class list. Thus, the test giver is able to note whether any test takers were absent. This matching may also be used to increase the accuracy with which the name of the test taker is recognized by allowing for best fit of letters in the test takers' names that may be have been misinterpreted by the intelligent character recognition system.

Further, in the various exemplary embodiments in which multiple classes or groups take substantially identical exams, the computer may grade and match the test takers to his/her respective individual class or group.

For example, a teacher may teach the same history class to three different class sections of students, wherein each class section meets with the teacher at a different class time. The teacher may give an identical or similar exam to each class section at different times. In grading the exams of more than one section at a time, the computer may match each individual student with each respective class section list.

Tests in which a student's name is not matched to a particular class list will still be graded and evaluated, but such tests will preferably be identified to the test giver as not matching the respective class list. A manual match may be performed by a test grader by examining the actual handwritten name on a test response sheet as scanned into the computer and comparing the scanned handwritten name to a list of test takers, e.g., a class list.

Tests given out on and completed on paper are scanned into a computer. Upon being scanned into the computer, answers handwritten by the test takers into the response region are read by one or more handwriting recognition programs. Upon being read by the one or more handwriting recognition programs, the answers input by the test takers are compared to the one or more acceptable answers to each associated question.

When comparing answers to the one or more accepted answers, the number of incorrect letters may also be analyzed. For example, if the test giver determines that zero misspellings are permitted in one or more particular answers given by test takers, then exact matches between the answer input by the test taker and the one or more acceptable answers must be made in order to earn given credit. If one or more misspellings are allowed, an algorithm is applied to determine whether or not the answer input by the test taker compared to the one or more acceptable answers by falling within the permissible range of misspellings allowed.

Each answer input by the test taker is analyzed in this way until each answer input is evaluated. The scanned tests showing the handwritten answers, the analyzed answers, and the grade given to each answer and overall test may be stored for later retrieval and review.

A test giver may be provided with a summary report. The summary report may show the number of correct answers, incorrect answers, or both for any given question and for the overall test. An individualized test report may also be provided to each test taker showing the test taker's actual handwritten response, the one or more acceptable answers, including those different from the test taker's response, and credit given to the test taker. In exemplary embodiments, the summary report can be automatically transferred to a school's or school system's grading database.

In an exemplary embodiment, a test giver may examine graphical images of the handwritten responses scanned into the computer based on a particular question as given by a particular test taker. Furthermore, a set of answers that received credit may be separated from a set of answers that did not receive credit, and a test giver may examine one or both set of answers. For example, the test giver may examine every handwritten answer provided by an entire class of students as scanned and evaluated for question number seven of a test. Likewise, the test giver may examine the handwritten answers as scanned and evaluated for an entire test as written by a test taker.

Further, one or more copies of the test comprising the one or more acceptable answers input in the one or more response regions by each of the test takers may also be created and viewed on paper or on a computer.

A test giver may modify the one or more acceptable answers and have the test re-evaluated and re-graded at any time. Modifying the one or more acceptable answers may include, for example, adding an acceptable answer, removing a previously acceptable answer, providing for partial credit, or a combination thereof.

In evaluating a test, a test giver may view any and all incorrect answers given for any particular answer. In doing so, the test giver may better evaluate whether or not there are additional acceptable answers, evaluate the handwriting recognition of the computer, evaluate the handwriting abilities of the individual students, and evaluate the question posed to the test takers.

In a preferred embodiment, the incorrect answers may be organized for display based on the associated question number, rather than based upon test taker. This may increase the speed at which the test giver can scan the entire set of incorrect answers.

The various exemplary embodiments allow for varied types of short-answer questions and answers in a test format. For example, as set forth above, there may be a question in which only one answer is required, such as, “Who was the president of the United States in 1990?” Another similar sort of question would be a true or false question requiring a test taker to write “true” or “false” or similar notation in the response region. Multiple choice questions would also be examples of questions requiring only one answer, typically seen by placing a single letter in a designated box or providing a predetermined mark next to a correct answer choice. In addition, responses to short-answer questions may be evaluated for particular keywords or phrases as determined by the test giver.

Test questions requiring only one input answer would preferably have a single response region into which the test taker would input an answer. Such exam format would be a type-one answer in which only a single answer is required, although that answer may take several forms.

Another type of test question is a question which requires two or more answers. An example of such a question would be, for example, “Name five of the original thirteen colonies of the United States.” In such a test question according to the various exemplary embodiments of the present invention, five response regions would be provided for a test taker to input an answer. That is, a test taker would provide a single response for each of the given response regions. Such exam format would be a type-two answer having two or more variable acceptable answers.

When evaluating and grading such test questions, the answer given in the first response region by the test taker is compared to a predetermined list of acceptable answers, that is, the thirteen colonies. If the test taker correctly identified Massachusetts as an original colony, then when evaluating and grading a second response region associated with the same question, Massachusetts would be removed from the list of acceptable answers because it was already correctly answered. Thus, a test taker would be preferably unable to list a single correct answer in the five response regions and get full credit for the question.

Another variation of test questions is where multiple answers by a test taker are required for a single question, and each of the multiple input answers must be in a proper sequence or order. This would be a type-three answer exemplified by the following question, for example, “What are the first five elements on the periodic table, in order?”

Whenever multiple answers are needed on the part of the test taker, the system may be set to allow for partial credit for individual answers.

The system for evaluating and grading answers to a test may be further programmed to “learn” from correct answers and recognize similar responses and phraseology that may be input by test takers and give credit. Such “learning” may be known in certain fields as latent semantic analysis.

For example, if a question asks, “What is Newton's first law of motion?” one of the acceptable answers may be “An object at rest, will tend to remain at rest.” However, latent semantic analysis may also deem “If it ain't moving, it won't start unless it gets pushed” as a correct answer, despite what might be considered poor grammar and language skills, as the concept behind the answer may be correct.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A method for efficiently and effectively creating, reviewing, assessing and grading short-answer type tests using a computer system, comprising:
creating a test, wherein a test giver compiles one or more test questions and identifies one or more response regions in which one or more responses to the one or more test questions may be input by one or more test takers;
designating one or more acceptable answers as correct responses to the one or more test questions, and inputting the one or more acceptable answers into a computing system;
distributing the test to the one or more test takers, wherein the one or more test takers input one or more responses to the one or more test questions in the one or more response regions such that the one or more responses may be input by manual handwriting or similar means;
collecting the tests;
scanning and converting the one or more responses input into the one or more response regions by the one or more test takers into an electronic format;
reviewing the one or more responses to the one or more test questions by the one or more test takers, wherein the one or more responses are compared to the one or more acceptable answers;
grading the tests based on a number of responses deemed to substantially compare the one or more acceptable answers to a respective question; and
assigning credit to each of the one or more test takers.

2. The method according to claim 1, further comprising providing a summary report to the test giver.

3. The method according to claim 2, wherein the summary report may identify the test takers, the one or more responses to each question, grades of test takers, average grades, number of correct or incorrect responses to each question, or a combination thereof.

4. The method according to claim 2, wherein the summary report can be automatically transferred to a school's or school system's grading database.

5. The method according to claim 1, further comprising providing an individual test report to a test taker.

6. The method according to claim 5, wherein the individual test report may identify the test taker's actual handwritten response, the one or more acceptable answers, and credit given to the test taker for each response given.

7. The method according to claim 1, wherein the short answers are type-one answers such that there is a single variable acceptable answer.

8. The method according to claim 1, wherein the short answers are type-two answers such that there are two or more variable acceptable answers.

9. The method according to claim 1, wherein the short answers are type-three answers such that multiple answers given in a particular sequence are required for a single question.

10. The method according to claim 1, wherein the one or more response regions are on a same page as the one or more test questions.

11. The method according to claim 1, wherein the one or more response regions are on a separate page from the one or more test questions.

12. The method according to claim 1, wherein the one or more response regions are on multiple pages, wherein each of the multiple pages have at least a single page number identifier.

13. The method according to claim 12, wherein there are at least three page number identifiers on each of the multiple pages.

14. The method according to claim 1, wherein the one or more response regions are identified with a border.

15. The method according to claim 1, wherein the distributing of the test is on paper.

16. The method according to claim 1, wherein the distributing of the test is via computer.

17. The method according to claim 1, wherein creating the test occurs on paper which is then scanned and input into the computing means.

18. The method according to claim 1, wherein in converting the input responses, intelligent character recognition converts the handwritten responses into a format recognized by the computing means.

19. The method according to claim 1, wherein when the test is on paper, the paper comprises multiple markers for identification by the computing means for proper positioning or realignment of the scanned paper.

20. The method according to claim 1, further comprising reviewing tests and credit assigned to each of the one or more test takers, and modifying the credit if desired.

21. The method according to claim 20, wherein the reviewing tests and credit may be performed by examining a graphical display of the handwritten responses as scanned and evaluated into the computer system.

22. The method according to claim 21, wherein examining the handwritten responses may be viewed as provided for one or more particular test takers, or by responses provided for a particular test question.

23. The method according to claim 1, wherein the creating the test is performed by a test giver using one or more predefined templates.

24. The method according to claim 1, wherein the computer system learns from responses predetermined and deemed correct by the test giver, in order to recognize similar responses from test takers as correct responses.

25. The method according to claim 1, wherein the test giver may predetermine the number of spelling errors permitted in a response and still accepted as a correct response by a test taker.
